(19) United States
(12) Patent Application Publication
(10) Pub. No.: US 2016/0328617 A1
(43) Pub. Date: Nov. 10, 2016

(54) PROTECTION SYSTEM, METHOD AND ELECTRONIC DEVICE WITH A PROTECTION FUNCTION

(71) Applicants: Fu Tai Hua Industry (Shenzhen) Co., Ltd., Shenzhen (CN); HON HAI PRECISION INDUSTRY CO., LTD., New Taipei (TW)

(72) Inventors: QIU-HONG XIE, Shenzhen (CN); YAO-CHANG LAN, Shenzhen (CN); FU-YEN HSIEH, New Taipei (TW)

(21) Appl. No.: 14/843,688

(22) Filed: Sep. 2, 2015

(30) Foreign Application Priority Data
May 6, 2015 (CN) 201510224186.3

(51) Int. Cl. G06K 9/00; H04N 5/232

(52) U.S. Cl. CPC G06K 9/00771; H04N 5/23206; H04N 5/23222

(57) ABSTRACT

A protection method includes controlling a camera unit to acquire video and/or image information surrounding the electronic device and controlling a positioning unit to acquire location information of the electronic device in response to an operation input via a triggering unit; acquiring the video and/or image information surrounding the electronic device from the camera unit and acquiring the location information of the electronic device from the positioning unit; and sending the acquired video and/or image information surrounding the electronic device and the location information of the electronic device to a contact person designated by a user via a communication unit.

### CROSS-REFERENCE TO RELATED APPLICATIONS

This application claims priority to Chinese Patent Application No. 201510224186.3 filed on May 6, 2015, the contents of which are incorporated by reference herein.

### FIELD

The present disclosure relates to electronic devices, especially relates to a kind of protection system, method and electronic device with a protection function.

### BACKGROUND

When people, especially women are out, safety is an important issue. It is helpful to provide a timely alert to the police when the people are in trouble.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device with a protection function.

FIG. 2 is a block diagram of an embodiment of a protection system.

FIG. 3 illustrates a flowchart of an embodiment of a method with a protection function.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

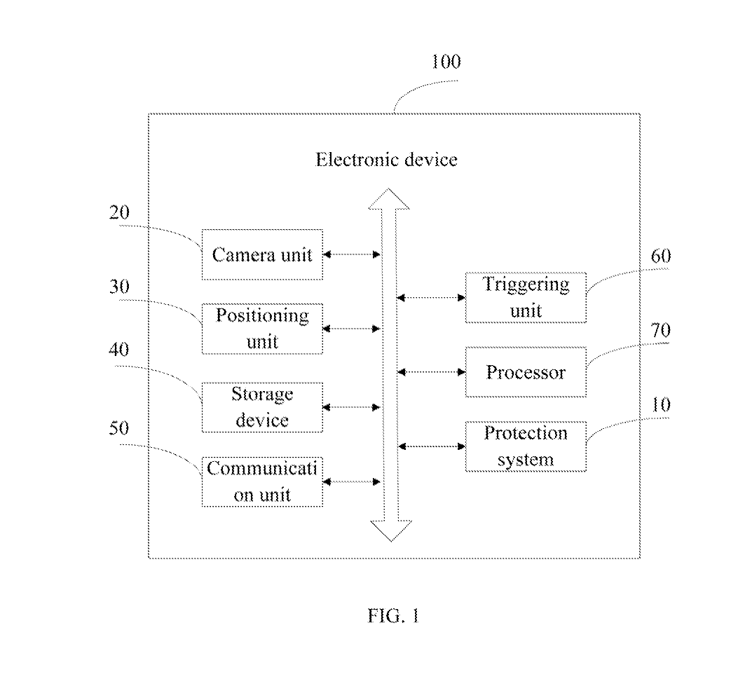

FIG. 1 illustrates a block diagram of an embodiment of an electronic device 100 with a protection function. The electronic device 100 has been installed with a protection system 10 and runs the protection system 10. In one embodiment, the electronic device 100 can be a smart phone, a tablet computer, a wearable device or other suitable electronic devices. The electronic device 100 includes, but is not limited to a camera unit 20, a positioning unit 30, a storage device 40, a communication unit 50, a triggering unit 60 and at least one processor 70.

The camera unit 20 is used to acquire video and/or image information surrounding the electronic device 100. In at least one embodiment, the camera unit 20 includes two cameras. One camera is set on a front surface of the electronic device 100 to acquire the video and/or image information of objects in front of the electronic device 100. The other camera is set on a back surface of the electronic device 100 to acquire the video and/or image information of objects in back of the electronic device 100. The positioning unit 30 is used to acquire location information of the electronic device 100. In at least one embodiment, the positioning unit 30 is Global Positioning System (GPS). The electronic device 100 is able to communicate with a communication device of a contact person designated by a user via the communication unit 50. In at least one embodiment, the communication unit 50 is a SIM (Subscriber Identity Module) card, a 3G (3rd Generation) card or a 4G (4th Generation) card. The triggering unit 60 is used to generate a trigger signal to run the protection system 10 in response to an operation. The processor 70 controls the camera unit 20 and the positioning unit 30 to start when the protection system 10 is running.

In one embodiment, the triggering unit 60 is a button of the electronic device 100, the at least one processor 70 starts to run the protection system 10 in response to the operation of the button being pressed by the user. In other embodiments, the triggering unit 60 is a touch screen, a shortcut icon corresponding to the protection system 10 is displayed on the touch screen, the at least one processor 70 starts to run the protection system 10 in response to the operation of the shortcut icon being clicked by the user.

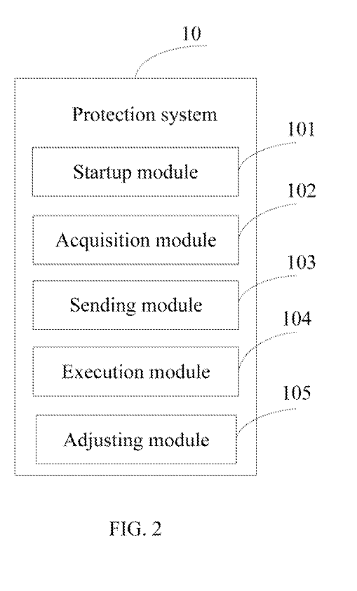

FIG. 2 illustrates a block diagram of an embodiment of the protection system 10, the protection system 10 includes a startup module 101, an acquisition module 102, a sending module 103, an execution module 104, and an adjusting module 105. The modules 101-105 of the protection system 10 can be collections of software instructions stored in the storage device 40 of the electronic device 100 and executed by the processor 70 of the electronic device 100. The modules 101-105 of the protection system 10 also can include functionality represented as hardware or integrated circuits, or as software and hardware combinations, such as a special-purpose processor or a general-purpose processor with special-purpose firmware.

The startup module 101 is configured to control the camera unit 20 to acquire the video and/or image information surrounding the electronic device 100 and control the positioning unit 30 to acquire the location information of the electronic device 100 in response to the operations input via the triggering unit 60.

The acquisition module 102 is configured to acquire the video and/or image information surrounding the electronic device 100 from the camera unit 20 and acquire the location information of the electronic device 100 from the positioning unit 30. In the embodiment, the acquisition module 102 acquires the video and/or image information surrounding the electronic device 100 from the camera unit 20 and acquires the location information of the electronic device 100 from the positioning unit 30 in real time.

The sending module 103 is configured to send the acquired video and/or image information surrounding the electronic device 100 and the location information of the electronic device 100 to the contact person designated by the user via the communication unit 50. In at least one embodiment, the sending module 103 sends the acquired video and/or image information surrounding the electronic device 100 and the location information of the electronic device 100 every a preset time, such as every 10 seconds. The preset time can be set by the user according to need or the configuration of the electronic device 100.

The execution module 104 is configured to execute a preset function after the sending module 103 sends the acquired video and/or image information of the environment surrounding the electronic device 100 and the location information of the electronic device 100 to the designated contact person. Usually, when the user is hurt by a suspect, the preset function being executed by the electronic device 100 can attract attention, and cause the suspect to view the electronic device 100, thus the information acquired by the acquisition module 102 would include the facial features of the suspect. In at least one embodiment, the preset function can be a virtual incoming call, or a playing song. In one embodiment, the execution module 104 executes the preset function after the sending module 103 sends the acquired video and/or image information surrounding the electronic device 100 and the location information of the electronic device 100 to the designated contact person a first time. In some other embodiments, the execution module 104 executes the preset function when receiving a reply message from the designated contact person after the sending module 103 sends the acquired video and/or image information surrounding the electronic device 100 and location information of the electronic device 100 to the designated contact person. Therein, the reply message from the designated contact person can be a short message or a message from an instant messaging software.

In the embodiment, after the execution module 104 executes the preset function, the sending module 103 determines facial features from the current video and/or image information acquired by the acquisition module 102, compares the determined facial features with the stored user facial feature information, and sends the current video and/or image information surrounding the electronic device 100 and the location information of the electronic device 100 acquired by the acquisition module 102 to the designated contact person only when the determined facial features do not match with the stored user facial feature information.

The sending module 103 determines whether the acquired video and/or image information includes facial features, and sends the acquired video and/or image information and location information of the electronic device 100 to the designated contact person when the acquired video and/or image information includes none of facial features. When the sending module 103 determines the acquired video and/or image information includes facial features, the sending module 103 further compares facial features with the stored user facial feature information; when the determined facial features do not match with the stored user facial feature information, the sending module 103 sends the acquired video and/or image information and location information of the electronic device 100 to the designated contact person; when the determined facial features match with the stored user facial feature information, the sending module 103 does not send the acquired video and/or image information and location information of the electronic device 100 to the designated contact person.

In one embodiment, each time the acquisition module 102 acquires the video and/or image information surrounding the electronic device 100 and the location information of the electronic device 100, the sending module 103 determines and compares the facial feature in the acquired video and/or image information with the stored user facial feature information, and sends the video and/or image information surrounding the electronic device 100 and the location information of the electronic device 100 to the designated contact person when the determined facial features do not match with the stored user facial feature information.

In other embodiments, when the acquisition module 102 acquires the video and/or image information surrounding the electronic device 100 and the location information of the electronic device 100, the sending module 103 sends the video and/or image information surrounding the electronic device 100 and the location information of the electronic device 100 to the designated contact person directly.

The adjusting module 105 is configured to set a work mode of the electronic device 100 as a mute mode and turn off a flash lamp of the camera unit 20 in response to the trigger signal generated by the triggering unit 60 when the triggering unit 60 is operated by the user. When the user operates the triggering unit 60 to cause the triggering unit 60 to generate the trigger signal, the adjusting module 105 determines the current work mode of the electronic device 100 and a status of the flash lamp of the camera unit 20, and sets the work model of the electronic device 100 as the mute mode, when the current work mode of the electronic device 100 is not the mute mode and turns off the flash lamp of the camera unit 20 when the flash lamp of the camera unit 20 is opened.

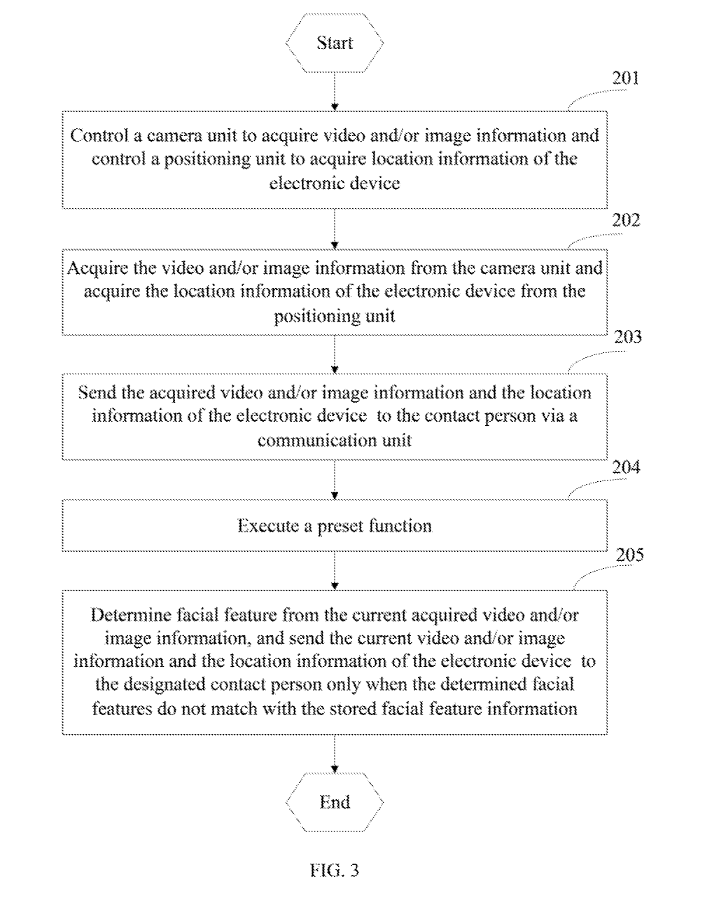

FIG. 3 illustrates a flowchart of a method with a protection function. The method is provided by way of example, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 201.

At block 201, a startup module controls a camera unit to acquire video and/or image information surrounding an electronic device and control a positioning unit to acquire location information of the electronic device in response to an operation input via a triggering unit.

At block 202, an acquisition module acquires the video and/or image information surrounding the electronic device from the camera unit and acquires the location information of the electronic device from the positioning unit.

At block 203, a sending module sends the acquired video and/or image information surrounding the electronic device and the location information of the electronic device to the contact person designated by the user via a communication unit. In at least one embodiment, the sending module sends the acquired video and/or image information surrounding the electronic device and the location information of the electronic device every preset time, such as every 10 seconds.

At block 204, an execution module executes a preset function after the sending module sends the acquired video and/or image information surrounding the electronic device and the location information of the electronic device to the designated contact person. Usually, when the user is hurt by a suspect, the preset function being executed by the electronic device can attract attention, and cause the suspect to view the electronic device, thus the information acquired by the acquisition module would include the facial features of the suspect. In at least one embodiment, the preset function can be a virtual incoming call, or a playing song.

In one embodiment, the execution module executes the preset function after the sending module sends the acquired video and/or image information surrounding the electronic device and the location information of the electronic device to the designated contact person the first time. In some other embodiments, the execution module executes the preset function when receiving a reply message from the designated contact person after the sending module sends the acquired video and/or image information surrounding the electronic device and location information of the electronic device to the designated contact person. Therein, the reply message from the designated contact person can be a short message or a message from an instant messaging software.

At block 205, the sending module determines facial features from the current video and/or image information acquired by the acquisition module, compares the determined facial features with the stored user facial feature information, and sends the current video and/or image information surrounding the electronic device and the location information of the electronic device acquired by the acquisition module to the designated contact person only when the determined facial features do not match with the stored facial feature information.

In the embodiment, the method further includes: a work mode of the electronic device as a mute mode is set by an adjusting module and turns off a flash lamp of the camera unit in response to the trigger signal generated by the triggering unit when the triggering unit is operated.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device with a protection function comprising:
a camera unit configured to acquire video and/or image information surrounding the electronic device;
a positioning unit configured to acquire location information of the electronic device;
at least one processor coupled to the camera unit and the positioning unit;
a communication unit coupled to the at least one processor;
a triggering unit coupled to the at least one processor and configured to generate a trigger signal; and
a non-transitory storage medium coupled to the at least one processor and configured to store a plurality of instructions, which cause the device to:
control the camera unit to acquire video and/or image information surrounding the electronic device;
control the positioning unit to acquire location information of the electronic device in response to an operation input via the triggering unit;
acquire the video and/or image information surrounding the electronic device from the camera unit;
acquire the location information of the electronic device from the positioning unit; and
send the acquired video and/or image information surrounding the electronic device and the location information of the electronic device to a contact person designated by a user via the communication unit.

2. The electronic device as recited in claim 1, wherein the plurality of instructions further configured to cause the device to:
execute a preset function on a certain condition.

3. The electronic device as recited in claim 2, wherein the plurality of instructions further configured to cause the device to:
determine facial feature from the current video and/or image information, comparing the determined facial feature with stored user facial feature information, and send the current video and/or image information surrounding the electronic device and the location information of the electronic device to the designated contact person only when the determined facial features do not match with the stored facial feature information.

4. The electronic device as recited in claim 2, wherein the plurality of instructions further configured to cause the device to:
execute the preset function after sending the acquired video and/or image information surrounding the electronic device and the location information of the electronic device to the designated contact person a first time.

5. The electronic device as recited in claim 2, wherein the plurality of instructions further configured to cause the device to:
execute the preset function when receiving a reply message from the designated contact person after sending the acquired video and/or image information surrounding the electronic device and location information of the electronic device to the designated contact person.

6. The electronic device as recited in claim 1, the plurality of instructions further configured to cause the device to:
set a work mode of the electronic device as a mute mode and turning off a flash lamp of the camera unit in response to the trigger signal generated by the triggering unit when the triggering unit is operated by the user.

7. The electronic device as recited in claim 1, wherein the electronic device can be a smart phone, a tablet computer, or a wearable device.

8. A protection system, run in an electronic device, the system comprising:
at least one processor; and
a plurality of modules which are collections of instructions executable by the processor, the plurality of modules comprising:
a startup module configured to, upon execution by the at least one processor, cause the at least one processor to control a camera unit to acquire video and/or image information surrounding the electronic device and control a positioning unit to acquire location information of the electronic device in response to an operation input via a triggering unit;
an acquisition module configured to, upon execution by the at least one processor, cause the at least one processor to acquire the video and/or image information surrounding the electronic device from the camera unit and acquire the location information of the electronic device from the positioning unit; and
a sending module configured to, upon execution by the at least one processor, cause the at least one processor to send the acquired video and/or image information surrounding the electronic device and the location information of the electronic device to a contact person designated by a user via a communication unit.

9. The protection system as recited in claim 8, wherein the plurality of modules further comprising:
an execution module configured to, upon execution by the at least one processor, cause the at least one processor to execute a preset function on a certain condition.

10. The protection system as recited in claim 9, wherein the sending module is further configured to, upon execution by the at least one processor, cause the at least one processor to determine facial feature from the current video and/or image information acquired by the acquisition module, compare the determined facial feature with stored user facial feature information, and send the current video and/or image information surrounding the electronic device and the location information of the electronic device acquired by the acquisition module to the designated contact person only when the determined facial features do not match with the stored facial feature information.

11. The protection system as recited in claim 9, wherein the execution module executes the preset function after the sending module sends the acquired video and/or image information surrounding the electronic device and the location information of the electronic device to the designated contact person a first time.

12. The protection system as recited in claim 9, wherein the execution module executes the preset function when receiving a reply message from the designated contact person after the sending module sends the acquired video and/or image information surrounding the electronic device and location information of the electronic device to the designated contact person.

13. The protection system as recited in claim 8, wherein the plurality of modules further comprising:
an adjusting module configured to, upon execution by the at least one processor, cause the at least one processor to set a work mode of the electronic device as a mute mode and turn off a flash lamp of the camera unit in response to the trigger signal generated by the triggering unit when the triggering unit is operated by the user.

14. A protection method comprising:
controlling a camera unit to acquire video and/or image information surrounding the electronic device and controlling a positioning unit to acquire location information of the electronic device in response to an operation input via a triggering unit;
acquiring the video and/or image information surrounding the electronic device from the camera unit and acquiring the location information of the electronic device from the positioning unit; and
sending the acquired video and/or image information surrounding the electronic device and the location information of the electronic device to a contact person designated by a user via a communication unit.

15. The protection method as recited in claim 14, wherein the method further comprising:
executing a preset function on a certain condition.

16. The protection method as recited in claim 15, wherein the method further comprising:
determining facial feature from the current acquired video and/or image information, comparing the determined facial feature with stored user facial feature information, and sending the current acquired video and/or image information surrounding the electronic device and the location information of the electronic device to the designated contact person only when the determined facial features do not match with the stored facial feature information.

17. The protection method as recited in claim 15, wherein the method further comprising:
executing the preset function after sending the acquired video and/or image information surrounding the electronic device and the location information of the electronic device to the designated contact person a first time.

18. The protection method as recited in claim 15, wherein the method further comprising:
executing the preset function when receiving a reply message from the designated contact person after sending the acquired video and/or image information surrounding the electronic device and location information of the electronic device to the designated contact person.

19. The protection method as recited in claim 14, wherein the method further comprising:
setting a work mode of the electronic device as a mute mode and turning off a flash lamp of the camera unit in response to the trigger signal generated by the triggering unit when the triggering unit is operated by the user.
